(19) United States
(12) Patent Application Publication
(10) Pub. No.: US 2008/0302307 A1
(43) Pub. Date: Dec. 11, 2008

(54) PET DISH WITH REPOSITIONABLE COVER

(75) Inventors: Patrick M. Bertsch, Thornton, CO (US); Neil Werde, Broomfield, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Aspen Pet Products, Inc., Denver, CO (US)

(21) Appl. No.: 11/759,445

(22) Filed: Jun. 7, 2007

(51) Int. Cl. A01K 5/01

(52) U.S. Cl. 119/61.5

(57) ABSTRACT

A pet dish may include a container and a repositionable cover. The container may define a holding space and an opening to access the holding space. The container may include a base, a first wall extending from the base, and a second end wall spaced apart from the first wall. The cover may be positionable on a first side of the container to close the opening. The cover may be positionable on a second side of the container such that at least a first portion of the cover extends beyond the container and at least a second portion of the cover is received within a space defined by the first and second walls. The cover may be joined to the container by a connection element, such as a strap.

### FIELD OF INVENTION

The present invention generally relates to food containers, and more particularly to pet dishes.

### BACKGROUND

Pet owners often use pet dishes when feeding their pets, such as dogs and cats. Many pet dishes include a bottom and a sidewall forming the shape of a bowl with an open top for the pet to access the food or water placed in the dish. Although the open top provides convenient access for the pet when feeding, the open top makes it difficult to transport a dish containing food or water from one location to another location. Further, the open top presents issues for storing food or water not consumed by the animal dish for future feedings.

Yet another issue with pet dishes is the animal often drops water or food around the dish while feeding. This dropped food and water may fall onto floors or counters supporting the pet dish and/or require the owner to clean up the area around the dish. Further, this food and/or water may stain or otherwise damage the floors, counters or other surfaces supporting the pet dish.

### SUMMARY OF THE INVENTION

One embodiment of the present invention may take the form of a pet dish comprising a container and a cover. The container may define a holding space and an opening to access the holding space. The container may include a base, a first wall extending from the base, and a second end wall spaced apart from and operably joined to the first wall. The cover may be positionable on a first side of the container to close the opening. The cover may be positionable on a second side of the container such that at least a first portion of the cover extends beyond the container and at least a second portion of the cover is received within a space defined by the first and second walls.

The cover may be joined to the container by a connection element. The connection element may be a strap. The connection element may be removably joined to the container and fixedly joined to the cover. The connection element may be received through a slit formed in the container.

### BRIEF DESCRIPTION OF THE DRAWINGS

FIG. 1 is a perspective view of an embodiment of a pet dish.

FIG. 2 is another perspective view of the pet dish of FIG. 1, showing the cover positioned on top of the dish.

FIG. 3 is a side view of the pet dish of FIG. 1, also showing the cover placed on top of the pet dish.

FIG. 4 is yet another perspective view of the pet dish of FIG. 1, showing the cover placed under the pet dish.

FIG. 5 is a cross-sectional view of the pet dish of FIG. 1, viewed along line 5-5 of FIG. 2.

FIG. 6 is a cross-section view of the pet dish of FIG. 1, viewed along line 6-6 of FIG. 4.

FIG. 7 is a perspective view of another embodiment of a pet dish.

FIG. 8 a side view of the pet dish of FIG. 7, showing the cover placed on top of the dish.

FIG. 9 is another perspective view of the pet dish of FIG. 7, showing the cover placed under the dish.

FIG. 10 is yet another perspective view of the pet dish of FIG. 7, showing the pet dish and a pet bowl.

FIG. 11 is a cross-sectional view of the pet dish of FIG. 7, viewed along line 11-11 of FIG. 7.

FIG. 12 is a cross-section view of the pet dish of FIG. 7, viewed along line 12-12 of FIG. 9.

### DETAILED DESCRIPTION

Described herein are various embodiments of a pet dish for use in feeding an animal, such as a dog, cat, or the like, or for receiving a pet bowl. The pet dish may take the form of a cover joined to a container by a connection element, such as a strap or the like. The cover may be positioned on top of container, beneath the container, or neither on top of nor underneath the container. When positioned on top of the container, the cover and the container define an enclosed chamber for storing food, water, or other items. When the cover is removed from the top of the container, an opening in the container is uncovered, thus providing access to food, water, or other items held within the container. When positioned underneath the container, the cover may catch food or water that may fall around the container. The container, the cover, and the connection element for the various embodiments of the pet dish described herein, or any other embodiment of the pet dish, may be formed from any plastic, including polyolefins, such as polyethylene or polypropylene, any other suitable material, such as a metal or an elastomer, or any combination thereof.

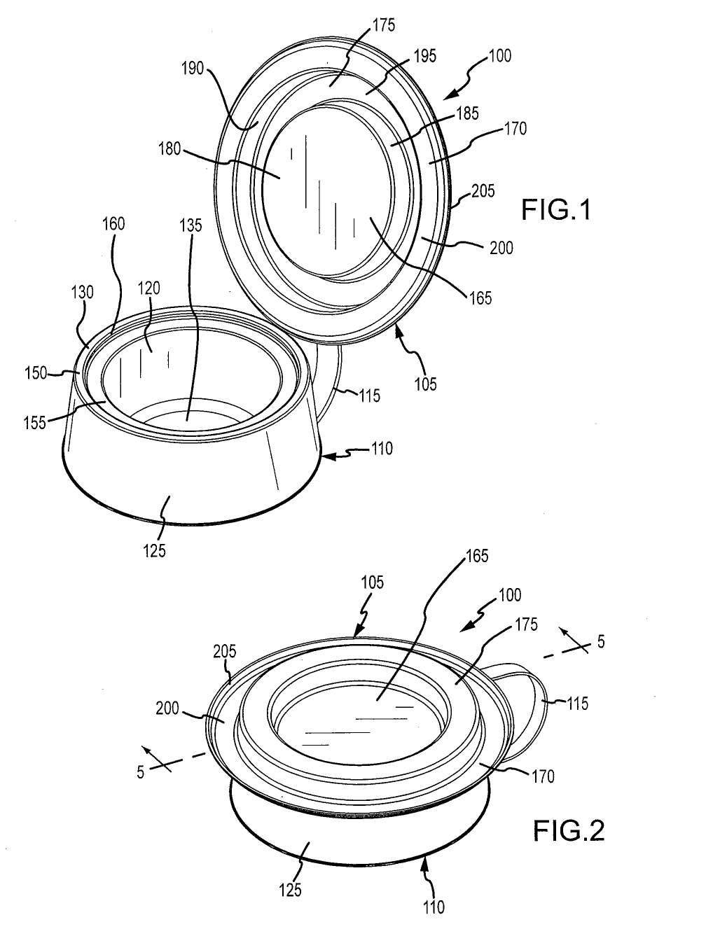

FIGS. 1-6 depict a first embodiment of a pet dish 100. With reference to FIG. 1, the pet dish 100 may include a cover 105 joined to a container 110 by a connection element 115, such as a strap or the like. The connection element 115 may keep the cover 105 from being separated from the container 110 when moving the cover 105 from one position to another relative to the container 110 and/or when the cover 105 is not positioned on top of or beneath the container 110. The container 110 may include inner and outer container walls 120, 125 joined at their respective upper ends by a container rim 130. The inner container wall 120 may extend upwardly from a container base 135. The inner container wall 120 and the container base 135 may define a space for receiving and holding food, water, or other objects. The space may be bowl-shaped or any other desired shape suitable for holding items. The container rim 130 formed at an upper end of the container 110 may define a container opening to provide access to the holding space. The container rim 130 may be stepped to form upper and lower container rim surfaces 150, 155 joined by a container rim wall 160. Each container rim surface 150, 155 may be generally annular or any other desired shape.

The cover 105 may include a plug portion 165 joined to a catch portion 170 by a connector portion 175. The plug portion 165 may include a cover base or bottom 180 configured for receipt within the container holding space. The cover base 180 may be generally circular or any other shape configured for receipt within the holding space. The plug portion 165 may further include an inner cover wall 185 extending upwardly from the base 180. The inner cover wall 185 may generally encircle the cover base 180. At least a portion of the inner cover 185 wall may be received within the container holding space.

The connector portion 175 may include the inner cover wall 185, an outer cover wall 190 positioned parallel to and spaced apart from the inner cover wall 185, and a cover flange 195 joining the inner cover wall 185 to the outer cover wall 190. The outer cover wall 190 may generally encircle the inner cover wall 185. The cover flange 195 may extend generally horizontally between upper sides of the inner and outer cover walls 185, 190. Together, the inner cover wall 185, the outer cover wall 190, and the cover flange 195 may define a connection space for receiving the container rim 130 and at least a portion of the inner and outer container walls 120, 125. The inner cover wall 185, the outer cover wall 190, and the cover flange 195 may each be annularly shaped or any other desired shaped suitable for defining a connection space for receiving at least a portion of the container 110 therein.

The catch portion 170 may include a cover rim 200 extending away from a lower end of the outer cover wall 190. The cover rim 200 may surround the outer cover wall 190 and may be generally annular shaped or any other desired shape. The cover rim 200 may be generally co-planar with the cover base 180. A cover lip 205 may extend upwardly from an outer perimeter of the cover rim 200 and may extend around the outer perimeter of the cover rim 200. The cover lip 205 may extend at an angle, or may extend vertically, from the cover rim 200. Together, the cover lip 205, the cover rim 200, and the outer cover wall 190 may define a catch area for catching food or water falling around the container 110 when the cover 105 is positioned underneath the container 110.

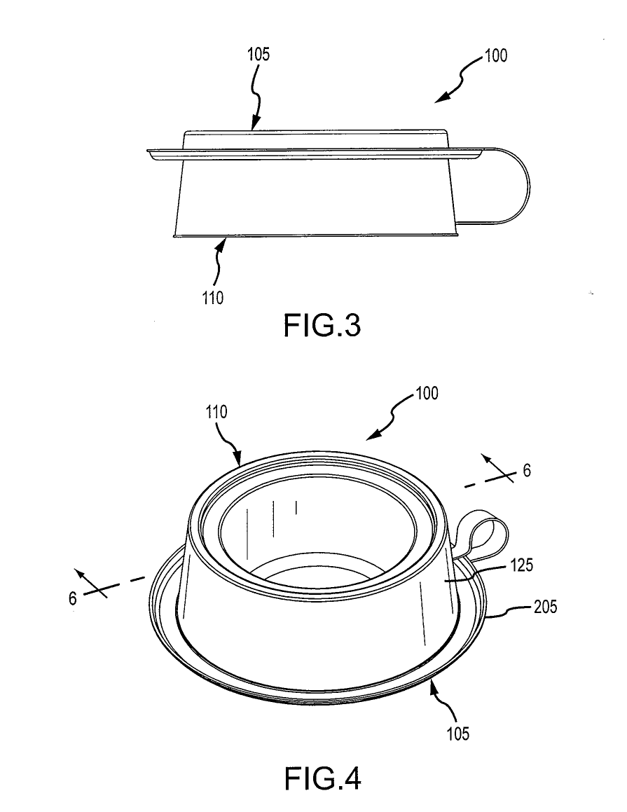

FIGS. 2 and 3 show the pet dish 100 with the cover 105 positioned on top of the container 110. In this position, the cover 105 may close the container opening. Closure of the container opening prevents or otherwise restricts access to the container holding space. As shown in FIG. 2, a portion of the cover 105, for example the cover rim 200, may extend beyond the container 110. Extending a portion of the cover 105 beyond the cover rim 200 may provide a grasping area on the cover 105 for a user to hold when removing the cover 105 from the container 110.

FIG. 4 shows the pet dish 100 with the cover 105 positioned underneath the container 110. In this position, the container opening is not covered, thus providing access to the container holding space. An animal, such as a dog or cat, may access any food or water placed within the container holding space. Further, in this configuration, at least a portion of the cover 105 may extend beyond the container 110. Additionally, the cover lip 205 may be spaced apart from the container outer wall 125 and may encircle the container 110. The container 110 and the portion of the cover 105 extending beyond the container 110 may define an area to retain food, water, or other items falling around the container 110, thus preventing, or minimizing, these items from contacting a floor, counter, or other surface supporting the container 110. Such retention may also aid a user when cleaning up around the container 110, especially after an animal has eaten from the container 110. For example, the user may carry a container 110 having food or water retained on the cover 105 to a trash can or a sink for disposal.

FIG. 5 depicts a cross-sectional view of the pet dish 100 with the cover 105 positioned on top of the container 110. As shown in FIG. 5, the cover base 180 and at least a portion of the inner cover wall 185 may be received between the inner container wall 120. When configured in this position, the cover 105 and container 110 may define a chamber. More particularly, the cover base 180, a portion of the inner container walls 120, and the container base 135 may define the chamber. The chamber may be air-tight. In particular, the cover base 180 may fill the opening to the container 110, the inner cover wall 185 may abut the inner container wall 120, the cover flange 195 may abut the upper container rim surface 150, and the outer cover wall 190 may abut the outer container wall 125, thus substantially limiting or preventing airflow between the chamber and the external environment.

The connection element 115, such as a strap or band, may be fixedly joined to the cover 105 by integrally forming the connection element 115 with the cover 105, sonically or heat welding the connection element 115 to the cover 105, or by using other known methods to fixedly join two or more components. In some embodiments, the connection element 115 may be removably joined to the cover 105 by, for example, joining the components using mechanical fasteners or other known methods to removably join two or more components.

The connection element 115 may be removably connected to the container 110. For example, as shown in FIG. 5, a portion of the connection element 115 may be received through a slit formed in the outer container wall 125. To retain the connection element 115 within the slit, a portion of the connection element 115 may define one or more beads 225. When the connection element 115 includes at least two beads 225, at least one bead 225 may be positioned on each side of the outer container wall 125. In the embodiment depicted in FIG. 5, six beads 225 are shown as formed on the connection element 115. In other embodiments, more or less than six beads 225 may be formed on the connection element 115. However, using at least two beads 225 allows at least one bead 225 to be positioned on each side of the outer container wall 125, thus generally limiting movement of the connection element 115 relative to the container 110 to between the beads 225.

More particularly, as the connection element 115 moves relative to the container 110 through the slit, a bead 225 may bear against the portions of the outer container wall 125 adjacent the slit, thus resisting further movement of the connection element 115 relative to the wall 125 in the direction causing the bead 225 to bear against the container 110. When a bead 225 is positioned on each side of the outer container wall 125 as shown in FIG. 5, movement of the connection element 115 towards and away from the container 110 through the slit is restricted respectively by the bead 225 positioned adjacent to and outside the outer container wall 125 and by the bead 225 positioned adjacent to the outer container wall 125 on the inner side of the outer container wall 125. However, the connection element 115 may be inserted through and removed from the slit by exerting sufficient force to overcome the bearing resistance between the bead 225 and the outer container wall 125. Thus, the connection element 115 may be readily attached and detached from the container 110 to disconnect the cover 105 from the container 110. A disconnected cover 105 may be replaced with another cover for use with the container 110, or vice versa. A disconnected container 110 and cover 105 may also be separately cleaned.

In other embodiments, the connection element 115 may be removably joined to the container 110 by other methods. For example, the connection element 115 may be removably joined to the container 110 by mechanical fasteners. In yet other embodiments, the connection element 115 may be fixedly joined to the container 110.

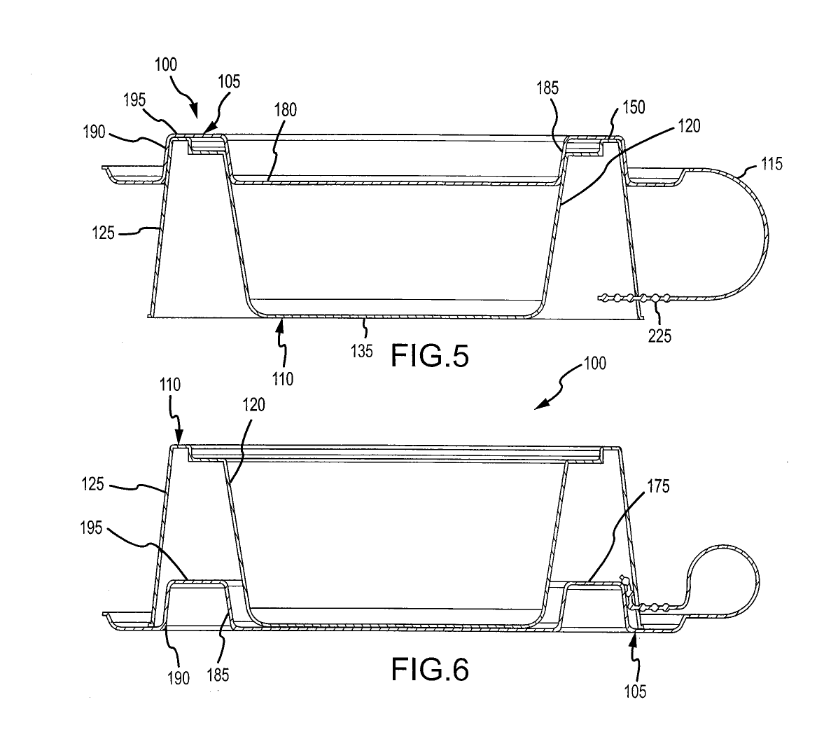

FIG. 6 is a cross-sectional view of the pet dish 100 with the cover 105 positioned under the container 110. As shown in FIG. 6, a portion of the cover 105 may be received with an area defined by the inner and outer container walls 120, 125. For example, the elements forming the connector portion 175 of the cover 105, such as the inner cover wall 185, the outer cover wall 190, and the cover flange 195, may be received between the inner and outer container walls 120, 125. When positioning the cover 105 under the container 110, one or more beads 225 of the connection element 115 may be pressed between the outer container wall 125 and the outer cover wall 190. In some embodiments, the bottom end portions of the inner and outer container walls 120, 125 may be joined by a container flange or beam. In such embodiments, a groove may be defined in the container flange or beam to receive the outer cover wall 190, the inner cover wall 185, and the cover flange 195 therein.

As shown in FIGS. 5 and 6, the connection element 115 may bend around itself as the cover 105 is moved from a position on top of the container 110 to a position under the container 110. More particularly, the connection element inner side as shown in FIG. 5 may become its outer side as shown in FIG. 6, and the connection element outer side as shown in FIG. 5 may become its inner side as shown in FIG. 6. Thus, the connection element 115 may be formed from a flexible material and/or have a minimum length to make it sufficiently flexible to bend about itself.

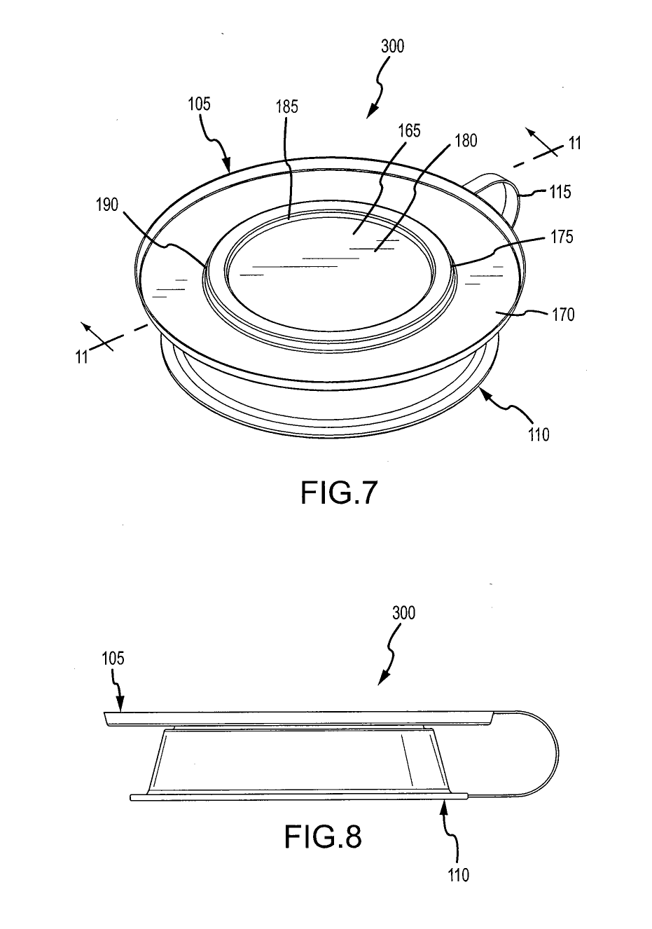

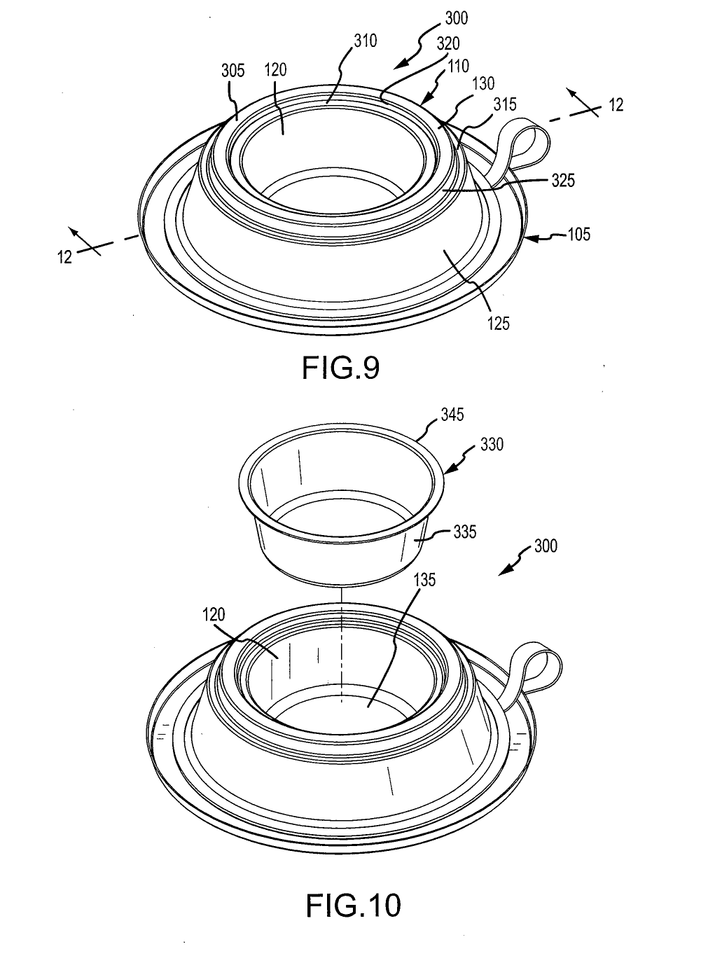

FIGS. 7-12 depict a second embodiment of the pet dish 300. The second embodiment is generally similar to the first embodiment, and like numbers may be used for the same or similar elements. For example, the second embodiment may include a cover 105 joined to a container 110 by a connection element 115. Further, the cover 105 may be positioned on top of the container 110 as shown in FIG. 7, or under the container 110 as shown in FIG. 9. Similar to the first embodiment, the cover 105 and container 110 may define a chamber for holding food, water, or other items when the cover 105 is positioned on top of the container 110, and a portion of the cover 105 may extend beyond the container 110 when positioned under the container 110 to define a region for catching and retaining food or water that may fall around the container 110.

FIGS. 7 and 8 depict the second embodiment of the pet dish 300 with the cover 105 positioned on top of the container 110. Like the first embodiment, the cover 105 may include a plug portion 105, a connector portion 175, and a catch portion 170. However, the inner and outer cover walls 185, 190 in the second embodiment may extend a relatively lesser distance above the cover base 180, thus resulting in the cover 105 for the second embodiment appearing more planar overall than the cover 105 of the first embodiment.

FIG. 9 depicts the second embodiment of the pet dish 300 with the cover 105 positioned under the container 110. Like the first embodiment, the container 110 for the second embodiment may include inner and outer container walls 120, 125 joined near their top portions by a container rim 130. The container rim 130, however, may be stepped twice to form an upper container rim surface 305, a lower inner container rim surface 310, and a lower outer container rim surface 315. Further, the upper container rim surface 305 and the lower inner container rim surface 310 may be joined by an inner container rim wall 320. Similarly, the upper container rim surface 305 and the lower outer container rim surface 315 may be joined by an outer container rim wall 325.

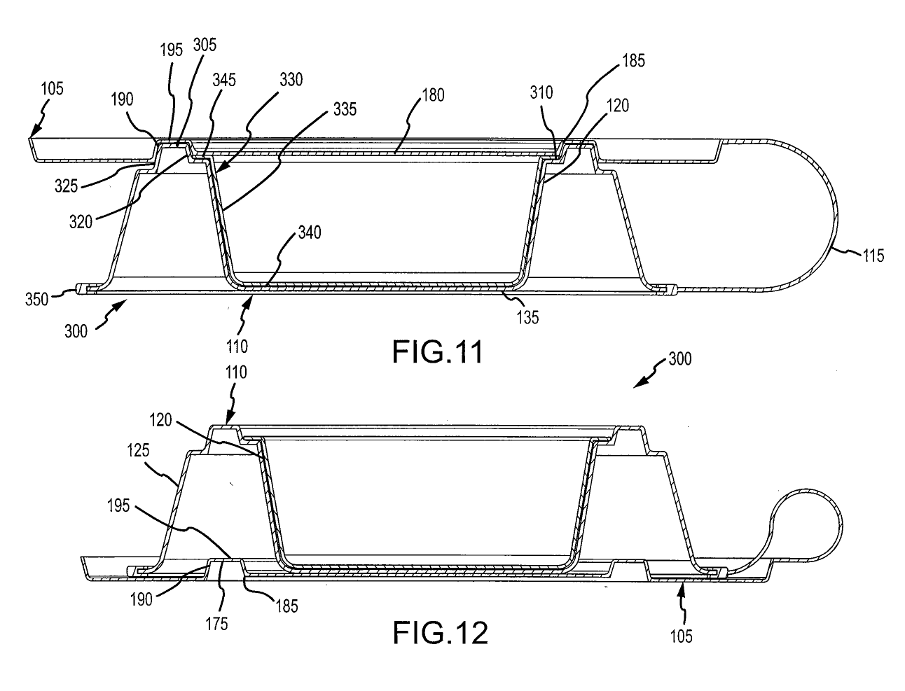

With reference to FIGS. 10 and 11, a pet bowl 330, such as a stainless steel pet bowl, may be received within the holding space defined by the inner container wall 120 and a container base 135. The pet bowl 330 may be a standard quart size pet bowl, or any other sized pet bowl. The pet bowl 330 may include a pet bowl wall 335 extending from a pet bowl base 340 to define a pet bowl space for receiving food or water. An upper end of the pet bowl wall 335 may define an opening for providing access to the pet bowl space. A pet bowl flange 345 may extend radially away from the upper end of the pet bowl wall 335. As shown in FIG. 11, the pet bowl base 340 may abut the container base 135, the pet bowl wall 335 may abut the inner container wall 120, and the pet bowl flange 345 may abut the lower inner container rim surface 310 when the pet bowl 330 is received within the container holding space. The pet bowl 330 may be readily removable from the pet dish 300 to clean the pet bowl 330 and/or to fill the pet bowl space with food or water.

The cover 105 and either the pet bowl 330 or the container 110 may define a chamber when the cover 105 closes the pet bowl opening or the container opening, respectively. The chamber may be air-tight. More particularly, the outer cover wall 190 may abut the outer container rim wall 325, a cover flange 195 may abut the upper container rim surface 305, and the inner cover wall 185 may abut the inner container rim wall 320, thus limiting or otherwise restricting air flow between an external environment and the chamber. Yet further, when the pet bowl 330 is received within the container holding space, a portion of the cover base 180 may abut the pet bowl flange 345, thus further limiting air flow between the external environment and the chamber.

The outer container wall 125 may curve near its bottom end. The curve may be concave on an outer side to transition the lower end of the outer container wall 125 from a generally vertical to a generally horizontal orientation. An outer container rim 350 may be attached proximate the lower end of the outer container wall 125. The outer container rim 350 may take the form of a ring including an annular groove for receiving the lower end of the outer container wall 125. The connection element 115, for example, a strap, may be fixedly joined to the outer container rim 350. The connection element 115 may further be fixedly attached to the cover 105. However, like the first embodiment, the connection element 115 may be removably joined to the outer container rim 350, the cover 105, or both for other embodiments of the pet dish 300.

FIG. 12 depicts a cross-sectional view of the second embodiment of the pet dish 300 with the cover 105 positioned under the container 110. Like the first embodiment, at least a portion of the cover 105 may be received between the inner and outer container walls 120, 125. For example, some of the elements forming the connector portion 175 of the cover 105, such as the inner cover wall 185, the outer cover wall 190, and the cover flange 195, may be received within a space or volume defined by the inner and outer container walls 120, 125. Further, like the first embodiment, a container flange configured to receive the connector portion 175, or other portions, of the cover 105 may join the outer container wall 125 to the inner container wall 120.

Any of the components or portions of components for the various embodiments of the pet dish described herein, including the cover, the container and the connection element may be formed from a single part, or may be formed from multiple parts joined together to create the component. The various parts may be integrally formed by methods such as injection molding, or may be joined by other methods such as by mechanical fastening, gluing or adhering, heat or sonically welding, and so on.

All directional references (e.g., upper, lower, upward, downward, left, right, leftward, rightward, top, bottom, above, below, inner, outer, vertical, horizontal, clockwise, and counterclockwise) are only used for identification purposes to aid the reader's understanding of the example of the invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A pet dish, comprising:
a container defining a holding space and an opening to access the holding space and including a base, a first wall extending from the base, and a second end wall spaced apart from and operably joined to the first wall; and
a cover; wherein
the cover is positionable on a first side of the container to close the opening, and the cover is positionable on a second side of the container such that at least a first portion of the cover extends beyond the container and at least a second portion of the cover is received within a space defined by the first and second walls.

2. The pet dish of claim 1, wherein the base and the first wall define the holding space.

3. The pet dish of claim 1, wherein the first wall and the second wall are operably joined by a rim.

4. The pet dish of claim 1, wherein the first side comprises a top end of the container and the second side comprises a bottom end of the container.

5. The pet dish of claim 1, further comprising a connection element joining the cover to the container.

6. The pet dish of claim 5, wherein the connection element comprises a strap.

7. The pet dish of claim 5, wherein the connection element is removably attached to the container.

8. The pet dish of claim 7, wherein the container includes a slit for receiving at least a portion of the connection element.

9. The pet dish of claim 8, wherein the connection element includes at least one bead for insertion through the slid.

10. The pet dish of claim 5, wherein the connection element is fixedly attached to the cover.

11. The pet dish of claim 10, wherein the connection element is integrally formed with the cover.

12. The pet dish of claim 1, wherein the cover and the container define a chamber when the cover is positioned on the first side of the container.

13. The pet dish of claim 12, wherein the chamber is air-tight.

14. The pet dish of claim 1, wherein the cover includes a plug portion, a connector portion, and a catch portion.

15. The pet dish of claim 14, wherein the at least the first portion of the cover includes the catch portion.

16. The pet dish of claim 14, wherein the at least the at least the second portion of the cover includes the connector portion.

17. The pet dish of claim 14, wherein at least a portion of the plug portion is received within the holding space when the cover is positioned on the first side of the container.

18. The pet dish of claim 14, wherein the catch portion includes a rim and a lip extending upwardly from an edge of the rim.

19. The pet dish of claim 1, wherein the container comprises a polyolefin.

20. The pet dish of claim 1, wherein the cover comprises a polyolefin
